(19) United States
(12) Patent Application Publication
(10) Pub. No.: US 2007/0153116 A1
(43) Pub. Date: Jul. 5, 2007

(54) Photographic device

(75) Inventors: Yoshizumi Nakao, Daito-shi (JP); Takashi Toyoda, Daito-shi (JP); Yasuo Masaki, Daito-shi (JP)

Correspondence Address: PILLSBURY WINTHROP SHAW PITTMAN, LLP, P.O. BOX 10500, MCLEAN, VA, 22102, US

(73) Assignee: FUNAI ELECTRIC CO., LTD., Osaka (JP)

(21) Appl. No.: 11/640,210

(22) Filed: Dec. 18, 2006

(30) Foreign Application Priority Data
Dec. 19, 2005 (JP) 2005-364575

(51) Int. Cl. H04N 5/225

(52) U.S. Cl. 348/340

(57) ABSTRACT

A photographic device includes an image sensor in which a plurality of pixels are arrayed. A horizontal scan circuit selects in order vertical drive lines to which the pixels are connected. And a vertical scan circuit reads voltages, due to accumulated electric charges, from the pixels in the horizontal row which is selected. A plurality of lenses are provided to the image sensor, arranged along the direction parallel to the vertical drive lines. Each of these lenses images an image of the same photographic region upon a pixel region which it confronts. The accumulated electric charges are read out from each pixel, arrayed in order. An image processing unit acquires a plurality of images of the photographic region spaced apart in time. And a moving body detection unit performs moving body detection from the differences between this plurality of images of the photographic region.

### CROSS REFERENCE

This Nonprovisional application claims priority under 35 U.S.C. § 119(a) on Patent Application No. 2005-364575 filed in Japan on Dec. 19, 2005, the entire contents of which are hereby incorporated by reference.

### BACKGROUND OF THE INVENTION

The present invention relates to a photographic device which photographs an image of a photographic region using an image sensor such as a CMOS image sensor or the like.

A prior art photographic device which performs detection of a moving body from a plurality of images is per se known. The photographic device disclosed in Japanese Laid-Open Patent Publication Heisei 08-106534 photographs a plurality of images of the same photographic region at predetermined time steps. This device performs moving body detection from the differential between a plurality of images.

With the device described above, in order to take a plurality of photographs of the same photographic region, it is necessary to perform photographic frame processing a plurality of times. In the above process , the device reads in accumulated electric charge from all of the pixels of the image sensor. With this type of device, a complicated structure and complicated processing are required. Furthermore, between processing each of the plurality of photographic frames and the next, a predetermined processing time period (a vertical flyback period or the like) has been required. Accordingly, with this type of device, there has been a limit to shortening the processing time period which is required for moving body detection.

Thus, an object of the present invention is to provide a photographic device which can acquire a plurality of photographic images of the same photographic region by performing the processing just once. Furthermore, it is also an object of the present invention to provide a photographic device which, with a simple structure and using simple signal processing, is capable of moving body detection in a short processing time period.

### SUMMARY OF THE INVENTION

The photographic device of this invention includes: an image sensor in which a plurality of pixels are arrayed in the form of a matrix; an imaging unit which forms images of the same photographic region upon each of a plurality of pixel regions into which the plurality of pixels are subdivided in a vertical direction; a row selection unit which selects the horizontal rows of the image sensor in order in the vertical direction; and a read out unit which reads out electric charge from each pixel of the horizontal row which has been selected by the row selection unit.

With this structure, a rolling shutter method is used in which the electric charges are read out while changing the horizontal rows in order. By doing this, predetermined time lag created at the timings at which the electric charges are read out from the various pixel regions. Accordingly, it is possible to acquire a plurality of images of the same photographic region which have been photographed at predetermined time steps with only a single episode of photographic frame processing. Moreover, it is possible to do this with simpler processing than in the prior art.

Furthermore, the above described time steps are determined according to the horizontal scan period at which the electric charges from the various pixels in a horizontal row are read out, and according to the number of horizontal rows in each pixel region. Accordingly, it is possible to acquire a plurality of images in a shorter time period than the frame rate or the horizontal flyback period or the like of the photographic device, so that it becomes possible to reduce the processing time period.

Furthermore, the imaging unit of this invention may form the images with lenses one of which is provided for each of the pixel regions. With this structure, the structure of the optical system elements is simple. Accordingly the optical design is simple and easy.

Moreover, the photographic device of this invention may further include a moving body detection unit which performs moving body detection using a plurality of images, one for each pixel region, which have been obtained from the electric charges read out by the read out unit. With this structure, it is possible to perform moving body detection within the photographic region with a single episode of photographic frame processing.

### BRIEF DESCRIPTION OF THE DRAWINGS

FIG. 1 is a block diagram showing a portion of the structure of a photographic device according to an embodiment of the present invention;

FIG. 2 is a conceptual figure for explanation of elements in the optical system of this embodiment; and

FIG. 3 is a conceptual figure for explanation of moving body detection processing in this embodiment.

### DETAILED DESCRIPTION OF THE INVENTION

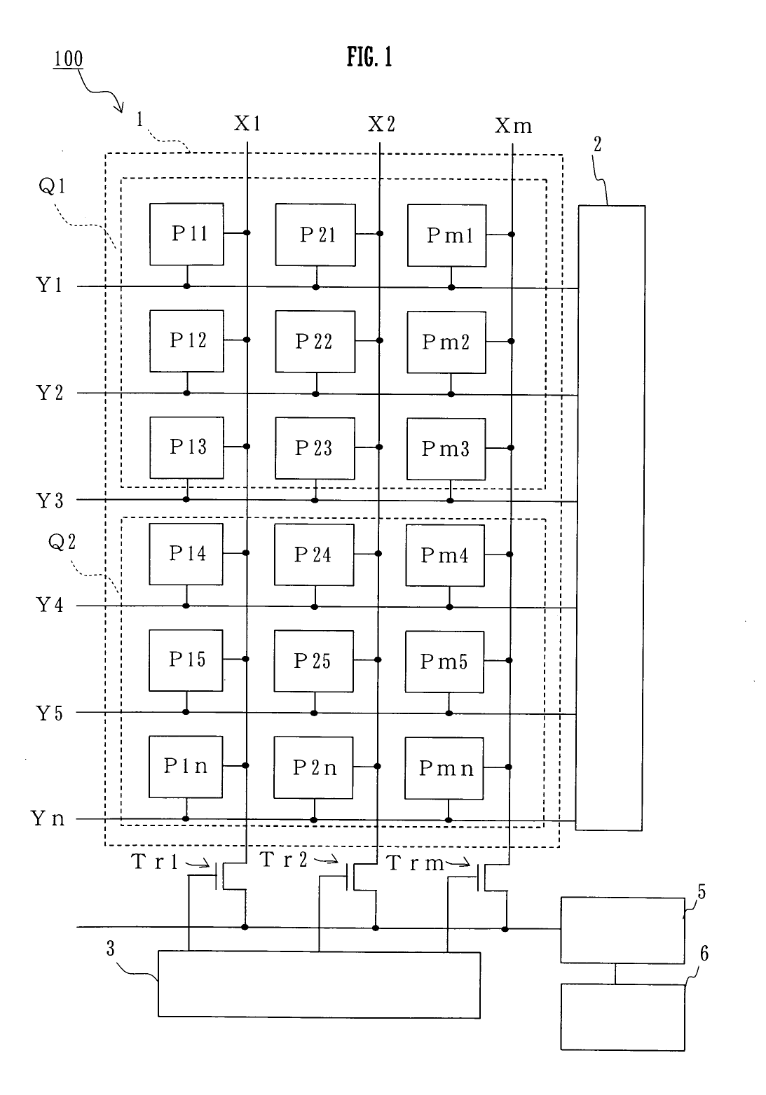

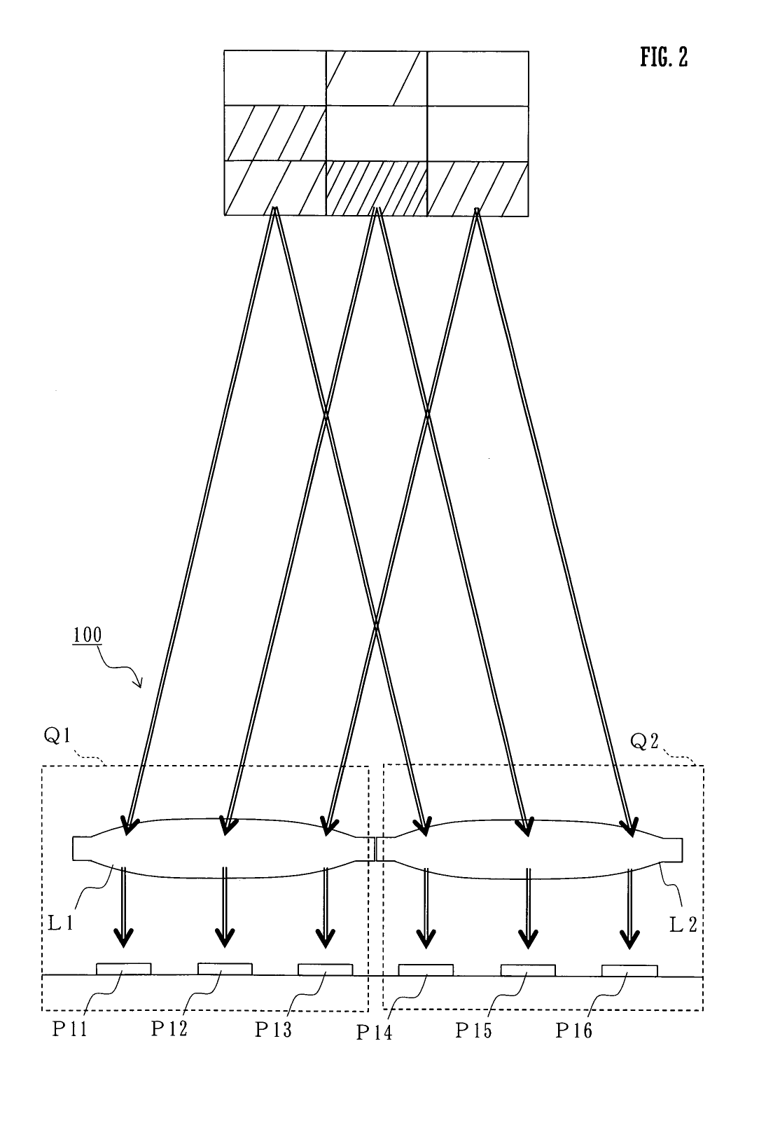

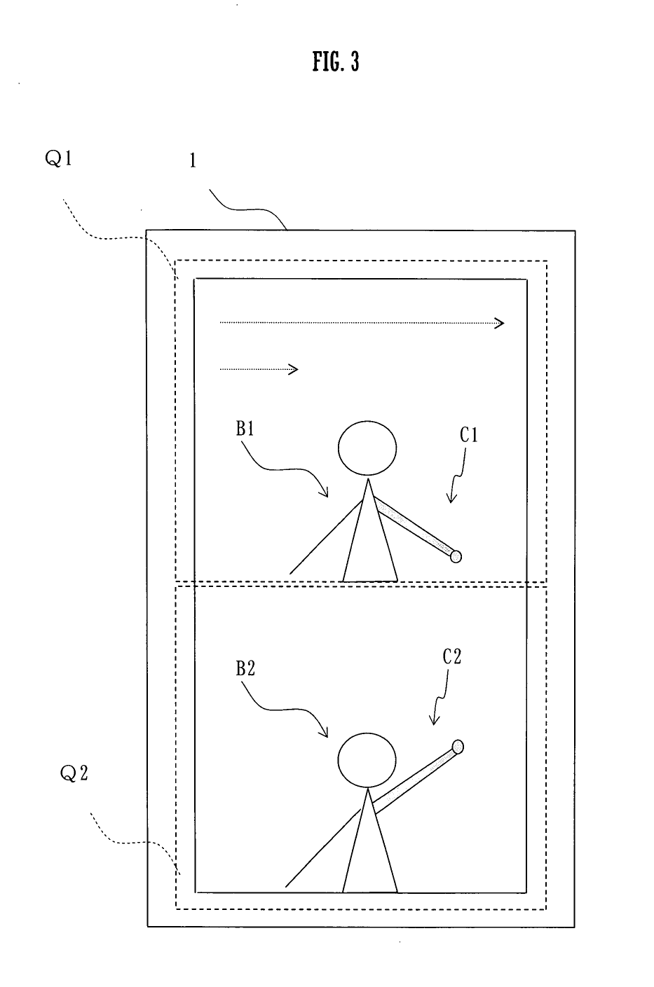

An embodiment of the present invention will now be explained. FIG. 1 is a block diagram showing a portion of the structure of a photographic device according to this embodiment. FIG. 2 is a conceptual figure for explanation of the focal point positions of certain elements in the optical system of this embodiment. And FIG. 3 is a conceptual figure for explanation of moving body detection processing by this embodiment.

The photographic device 100 shown in FIG. 1 comprises an image sensor 1 in which a plurality of pixels P11˜Pmn (m and n are positive integers) are arranged in the form of a matrix. This image sensor 1 faces an object to be photographed, via optical system elements not shown in the figure.

It should be understood that although here, for the convenience of illustration, an image sensor 1 with a reduced number of pixels is explained, in actual practice it is preferred for it to have several tens of thousands of pixels or more. Furthermore, although actually various types of signal lines other than those shown in the figure (such as signal lines for reset signals and the like) are connected to each of the pixels P11˜Pmn, the explanation thereof is omitted in this specification, since such signal lines bear no direct relationship to the essence of the present invention. A structure like that of a typical image sensor such as a CMOS image sensor or the like will be acceptable.

Each of the plurality of pixels which are lined up in each horizontal row across the image sensor 1 (i.e. in the horizontal direction in FIG. 1) is connected to the same horizontal drive line. And the one ends of these horizontal drive lines are connected to a vertical scan circuit 2. This vertical scan circuit 2 corresponds to the “selection unit” of the Claims of this application, and is a circuit which selects the horizontal rows of the image sensor 1 in sequence while shifting its timing for doing so.

Here, as shown in FIG. 1, a horizontal drive line Y1 is connected to the pixels P11, P21, Pm1 which are lined up in the first horizontal row. In the same manner, a horizontal drive line Y2 is connected to the pixels P12, P22, Pm2; a horizontal drive line Y3 is connected to the pixels P13, P23, Pm3; a horizontal drive line Y4 is connected to the pixels P14, P24, Pm4; a horizontal drive line Y5 is connected to the pixels P15, P25, Pm5; and a horizontal drive line Yn is connected to the pixels P1n, P2n, Pmn. One end of each of these horizontal drive lines Y1 through Yn is connected to the vertical scan circuit 2.

Furthermore, each of the plurality of pixels which are lined up in each vertical column across the image sensor 1 is connected to the same vertical drive line. One end of each of these vertical drive lines is connected to the image processing unit 5 via a switching circuit such as a transistor or the like. And the horizontal scan circuit 3 is connected to each of these switching circuits. The horizontal scan circuit 3 and the switching circuits correspond to the “read out unit” of the Claims, and constitute a circuit which reads out the electric charge from each pixel of the horizontal row which is selected.

Thus, a vertical drive line Xl is connected to the pixels P11, P12, P13, P14, P15, P1n which are lined up in one vertical column. In the same manner, a vertical drive line X2 is connected to the pixels P21, P22, P23, P24, P25, P2n; and a vertical drive line Xm is connected to the pixels Pm1, Pm2, Pm3, Pm4, Pm5, Pmn. And the one ends of these vertical drive lines X1˜Xm are connected to the image processing unit 5, via respective transistors Tr1, Tr2, Trm which constitute switching circuits. The bases of these transistors Tr1, Tr2, Trm are connected to the horizontal scan circuit 3. This horizontal scan circuit 3 performs switching.

Furthermore, the plurality of pixels upon the image sensor 1 are subdivided into a plurality of pixel regions Q1, Q2 which are stacked in the direction perpendicular to the rows, in other words stacked in the vertical scan direction. Thus, as shown in FIG. 2, respective pixel regions Q1, Q2 are provided corresponding to optical lenses L1, L2. The pixel region Q1 comprises the pixels P11, P12, P13, P21, P22, P23, Pm1, Pm2, Pm3. Moreover, the pixel region Q2 comprises the pixels P14, P15, P1n, P24, P25, P2n, Pm4, Pm5, Pmn. Here, the optical lenses L1, L2 correspond to the “imaging unit” of the Claims. It should be understood that this optical unit is not limited to being the optical lenses L1, L2 shown here; it would also be acceptable to employ any other type of optical elements, provided that they are ones which are arranged so as to image the same image upon each of the pixel regions. Moreover, it should be understood that it would also be acceptable to provide a light shielding barrier at the boundary portion of each of the pixel regions, in order to prevent the light which is incident from each of the optical lenses L1, L2 from straying into the adjacent pixel region.

The focal point positions of the optical lenses L1, L2 are set so that an image of the same photographic region is imaged upon a plurality of pixel regions Q1, Q2, respectively. It is arranged for the incident light from the same focal point position to be incident upon the pixel P11 of the pixel region Q1 and upon the pixel P14 of the pixel region Q2. And it is arranged for the incident light from the same focal point position to be incident upon the pixel P12 and upon the pixel P15. Similarly, it is arranged for the incident light from the same focal point position to be incident upon the pixel P13 and upon the pixel P16.

The vertical scan circuit 2 and the horizontal scan circuit 3 shown in FIG. 1 perform photographic frame processing, and read out the voltages due to accumulated electric charge from all of the pixels of the image sensor 1 in order by the rolling shutter method. The vertical scan circuit 2 creates a vertical scan pulse. This vertical scan pulse is sequentially outputted to the horizontal drive lines Y1˜Yn. In this manner, the horizontal rows of the image sensor 1 are selected sequentially. The voltages due to the electric charges accumulated upon the photodiodes of the pixels upon the horizontal row which is selected are outputted to the vertical drive lines X1˜Xm which are respectively connected thereto.

While a horizontal row is being selected by the vertical scan circuit 2, the horizontal scan circuit 3 creates a horizontal scan pulse. This horizontal scan pulse is sequentially outputted to the bases of the transistors Tr1-Trm. In this manner, each of the pixels in the horizontal row which is currently selected by the vertical scan circuit 2 is scanned. When supplied with the horizontal scan pulse, each of the transistors Tr1˜Trm outputs, to the image processing unit 5, the voltage from the vertical drive line which is respectively connected to it due to the accumulated electric charge upon the corresponding pixel of the selected horizontal row.

The photographic device 100 described above performs processing of photographic frames by the rolling shutter method. Since images of the same photographic region are imaged upon both the pixel region Q1 and the pixel region Q2, accordingly, from the image sensor 1 as shown in FIG. 1, the voltages due to the accumulated electric charges are read out in order from the horizontal row at the top in FIG. 1 to the horizontal row at the bottom therein, and, within each row, from the pixel at its left end in FIG. 1 to the pixel at its right end therein. Accordingly, the timings for reading out the voltages due to the accumulated electric charges from the two pixel regions Q1, Q2 are different from one another. When reading out the voltage due to the accumulated electric charge from the head pixels of each of these pixel regions Q1, Q2, a predetermined time difference is created according to the horizontal scan period for each horizontal row, and according to the number of horizontal rows in each of the pixel regions.

Accordingly if (hypothetically), during one episode of photographic frame processing, the object to be photographed (a person) has moved his arm from a lower angle towards an upper angle, then, as shown in FIG. 3, the arm C1 in the image B1 which is obtained from the pixel region Q1 is photographed as shown in the upper part of that figure, while the arm C2 in the image B2 which is obtained from the pixel region Q2 is photographed as shown in the lower part thereof.

The image processing unit 5 shown in FIG. 1 acquires, from the voltages due to the accumulated electric charges which have been thus read out, a plurality of images which have been photographed at predetermined time steps. And the image processing unit 5 performs per se conventional image processing upon each of these acquired images, such as y compensation and white balance processing and the like. By doing this, with the photographic device 100 of this embodiment, it is possible to acquire, in a single episode of photographic frame processing, a plurality of images which have been obtained by photographing the same photographic region at predetermined time steps.

After having been image processed by the image processing unit 5, the image is outputted to the next stage, which is a moving body detection unit 6. The moving body detection unit 6 compares the image B1 and the image B2. And, moreover, the moving body detection unit 6 extracts the arm C1 in the image B1 and the arm C2 in the image B2, based on the difference between the image B1 and the image B2. By doing this, the moving portions within the image are identified by the photographic device 100 of this embodiment, so that moving bodies within the image are detected.

As described above, with the photographic device 100 of this embodiment, with only a single episode of photographic frame processing, it is possible to detect a moving body by acquiring a plurality of images of the same photographic region which have been photographed at predetermined time steps. Furthermore, even though the signal processing is performed with a simple structure, it becomes possible to detect a moving body while minimizing the processing time required. Moreover, it is possible to detect a moving body even though the drive frequency of the photographic device may be low, so that it is possible to reduce the amount of electric power consumption.

It should be understood that it would also be acceptable to implement the processing by the image processing unit 5 and the moving body detection unit 6 described above by software processing using an image processing IC or a CPU or the like. Furthermore, as a component of the optical system, it is preferred to provide, in addition to the optical lenses, also an optical throttle or an optical filter or the like. Moreover, it would also be acceptable to arrange to divide the photographic region of the image sensor into more regions than two.

This type of photographic device may, for example, be provided as an accessory to a television device, and may be utilized as a device which is adapted to recognize gestures of human beings. Apart from this, it may also be utilized in a monitoring camera system, an onboard camera system, a portable video recorder, a digital camera, or the like.

Thus, the present invention may be implemented as various different embodiments other than the one shown, provided that the gist of the present invention is not departed from.

Finally, in the above described explanation of an embodiment of the present invention, all of the features are shown by way of example, and should not be considered as being limitative of the present invention. The scope of the present invention is not to be defined by any of the features of the embodiment described above, but only be the scope of the appended Claims. Moreover, equivalents to elements in the Claims, and variations within their legitimate and proper scope, are also to be considered as being included within the range of the present invention.

What is claimed is:

1. A photographic device, comprising:
an image sensor in which a plurality of pixels are arrayed in the form of a matrix;
an imaging unit which forms images of the same photographic region upon each of a plurality of pixel regions into which the plurality of pixels are subdivided in a vertical direction;
a row selection unit which selects the horizontal rows of the image sensor in order in the vertical direction; and
a read out unit which reads out electric charge from each pixel of the horizontal row which has been selected by the row selection unit.

2. A photographic device as described in claim 1, further comprising a moving body detection unit which performs moving body detection using a plurality of images, one for each pixel region, which have been obtained from the electric charges read out by the read out unit.

3. A photographic device as described in claim 1, wherein the imaging unit forms the images with lenses one of which is provided for each of the pixel regions.

4. A photographic device as described in claim 3, further comprising a moving body detection unit which performs moving body detection using a plurality of images, one for each pixel region, which have been obtained from the electric charges read out by the read out unit.
